(19) United States
(12) Patent Application Publication
(10) Pub. No.: US 2003/0182188 A1
(43) Pub. Date: Sep. 25, 2003

(54) System and method for providing electronic vouchers

(76) Inventor: Mark Duchow, Pewaukee, WI (US)

Correspondence Address: Michael K. Lindsey, Howrey Simon Arnold & White, Suite 800, 321 N. Clark, Chicago, IL, 60610, US

(21) Appl. No.: 10/286,522

(22) Filed: Feb. 24, 2003

Related U.S. Application Data
(63) Continuation-in-part of application No. 09/682,876, filed on Oct. 26, 2001.

(51) Int. Cl. G06F 17/60

(52) U.S. Cl. 705/14

(57) ABSTRACT

The system and method provide access to a website by a buyer via the Internet. A list of producers is displayed to the buyer and a producer selection is received from the buyer. A list of products, based on the producer selection, is displayed to the buyer and a product selection is received from the buyer. Buyer information is requested from the buyer, such as the buyer's zip code and email address, the buyer information is received from the buyer, and the buyer information is stored in memory. Through a computer program, a reseller, located closest to the buyer, is selected from a reseller database, based on the buyer information and a cash value discount and expiration date are selected from a discount database based on the product selection. Finally, an electronic voucher is sent to the buyer via email containing the producer and product selections, the reseller, the cash value discount, and the expiration date.

### CROSS-REFERENCE TO RELATED APPLICATIONS

This application is a continuation-in-part of prior application Ser. No. 09/682,876, filed Oct. 26, 2001.

### TECHNICAL FIELD OF THE INVENTION

The present invention generally relates to electronic commerce, and more particularly to a system and a method for providing electronic vouchers via the Internet that can be used towards the purchase of products.

### BACKGROUND OF THE INVENTION

The Internet has become a powerful commercial resource, providing significant opportunities for the marketing, advertising, and promotion of products to a worldwide audience. On-line marketing, advertising, and promotion are increasingly important in today's competitive marketplace. However, the Internet, like any other medium, has inherent advantages and disadvantages.

Some of the disadvantages stem from using the Internet to market, advertise, and promote products that are sold through various distribution systems. For example, in a simple version of a product distribution system there is a producer. As used herein, a producer is an entity that is identified as the source of a good and/or service. The producer may be the manufacturer of a good, it may employ a contract manufacturer to actually make its goods, or it can be the provider of a service. The producer has a distribution system that includes numerous resellers who sell the product of the producer. Finally there are buyers who purchase the product of the producer from the resellers. In actuality, product distribution systems may be much more complex than that described above having many levels of resellers and buyers within the system. However, the disadvantages of using the Internet for the marketing, advertising, and promotion of products of a producer are present no matter the level of complexity of the distribution system.

One limitation of marketing websites, i.e., those devoted to marketing, advertising, and promoting products that are sold through a distribution system, is that they are informational in nature, and fail to provide specific incentives to encourage prospective buyers to make a purchase decision.

Sometimes, marketing websites fail to provide even basic information, such as the locations of resellers where the products can be purchased. To encourage purchases, the buyer should be given a motivation to purchase the products. For example, providing buyers with favorable prices for the producer's products is typically a prime motivator in stimulating a purchase, whereas providing the buyer with the retail or “Suggested-List” price for a product is not typically a strong purchase motivator. However, in many situations, a producer marketing, advertising, or promoting products that are sold through resellers over the Internet cannot promote a price other than a “Suggested-List” price. If they were to promote a specific price, producers could undermine independent pricing strategies created by their resellers. Conversely, resellers cannot advertise specific prices over the Internet because such advertising would be global in nature, and extend beyond the reseller's territorial boundaries.

A further disadvantage is encountered when the distribution system of the producer assigns geographic areas (“territories”) to each reseller. In these types of systems, each reseller is given primary responsibility for the market within their territory and typically spends much time and money advertising, marketing, and promoting the producer's product within their assigned territory. In this type of distribution system, in addition to not being able to promote a sale price over the Internet as stated above, a producer cannot typically provide any type of global discount or incentive voucher to buyers without some type of restriction as to where the buyer can redeem the voucher. If a producer were to provide global vouchers to buyers, the buyer could take the voucher and redeem it at a reseller that is in a territory outside of where the buyer is located. If this is done, it is possible that the producer could be seen as providing incentives to buyers that are injuring the reseller that is losing the sales. This type of global incentive could thus be perceived as allowing certain resellers to free ride on the time and money expended by other resellers to market, advertise, and promote the products within their own territory, thereby penalizing some resellers by having them expend the money and not make the sale within their territory and may cause problems within the producer's distribution system.

For example, a producer may provide buyers with vouchers that are redeemable for a cash discount off of the sale price of a product without any restriction as to where the voucher can be redeemed. The buyers in Illinois that receive these vouchers decide to go to the reseller in Wisconsin rather than the reseller in Illinois to redeem the vouchers because the reseller in Wisconsin has a lower sale price than the reseller in Illinois. However, since the cost of doing business for the reseller in Illinois is more expensive than that of the reseller in Wisconsin, the reseller in Illinois cannot sell the product for as low a price as the reseller in Wisconsin without losing money on each sale. Therefore, although the reseller in Illinois has spent time and money developing the Illinois market, buyers are going to Wisconsin to redeem the vouchers. In this case, the Illinois reseller may see the producer as undermining its efforts to sell products in Illinois and decide that it no longer wants to sell the producer's products, thereby leaving the producer with no distribution in Illinois.

The net result is that producers and resellers that sell products within distribution systems are currently constrained from effectively marketing, advertising, and promoting products over the Internet using the most effective buying incentive at their disposal: a specific monetary incentive for the products they sell.

Thus, there is a need for an improved system for promoting products over the Internet that does not interfere with established territories of resellers in a pre-existing distribution system.

### BRIEF SUMMARY OF THE INVENTION

The current invention avoids problems inherent in currently available systems and methods for using the Internet for marketing, advertising, and promotion of products sold through resellers within distribution systems. The systems and methods disclosed and claimed herein provide considerable benefit to consumers, resellers, and producers alike.

The present invention provides an electronic voucher that contains a specific incentive, such as a discount on the purchase price, cash back, free accessories, free upgrades, or the like, rather than providing a specific price, thereby allowing each reseller to set its own price, while providing a powerful incentive to buyers to purchase the products. For example, if the incentive is a discount on the purchase price, the buyer must contact or visit a specific reseller to receive that reseller's selling price and then apply the specific discount on the electronic voucher to that reseller's selling price, an approach that is both desirable and preferable.

The electronic voucher also directs the buyer to a specific reseller for redemption of the incentive rather than allowing a buyer to go to any reseller for redemption. This benefits the consumer by providing the nearest reseller location and also benefits the reseller by permitting each reseller to charge whatever price they wish for the product. It also eliminates the possibility of resellers attempting to sell the products, using the incentive, to buyers that are located outside of their assigned territories, and allows producers to channel buyers to the location appropriate for the purchase to occur based on their particular distribution structure. Accordingly, within a pre-existing territorial distribution system, both producers and reseller can employ the present invention to promote products without upsetting established marketing practices.

The present invention can provide an incentive specific to individual products, allowing both producers and resellers to control which products will be given an incentive. This is highly beneficial in terms of inventory management and profit margin control.

In addition, the present invention can provide the electronic voucher to the buyer over a computer network confirming the benefit that will be received if the buyer visits the reseller in the appropriate geographic or product area. The discount can also include a specific expiration date, encouraging the prospective buyer to make a prompt decision. The combination of a specific incentive with and expiration date is an effective method to create urgency from the buyer's standpoint.

In accordance with an embodiment of the present invention, a reseller website is accessible by a computing device via a network. A promotion website is linked to the reseller website. A computer program is executable through the promotion website, can receive buyer information, can determine if the linking reseller is correct based on the buyer information, and can select a reseller based on the buyer information if the linking reseller is not correct. The computer program has access to a memory device for storing information received. Finally, the computer program can send information to the computing device over a network.

In accordance with a further embodiment of the present invention, a reseller website is accessible by a computing device via a network. A promotion website is linked to the reseller website. A product webpage is linked to the promotion website. A computer program is executable through the product webpage, can receive buyer information, can determine if the linking reseller is correct based on the buyer information, and can select a reseller based on the buyer information if the linking reseller is not correct. The computer program has access to a memory device for storing information received. In addition, the computer program can send information to the computing device over a network.

In accordance with another embodiment of the invention, a method of providing a purchasing incentive is provided. According to the method, access is provided to a reseller website to a buyer via a network. A promotion is displayed, a promotion selection received, and a link provided to a promotion website based on the promotion selection. A linking reseller is determined from the reseller website. Buyer information is requested, received, and stored in a memory device and a determination is made whether or not the linking reseller is correct based on the buyer information. If the linking reseller is not correct, a reseller is selected based on the buyer information. Then, purchasing information is communicated to the buyer.

Other embodiments, features and advantages of the invention will be or will become apparent to one with skill in the art upon examination of the following figures and detailed description. It is intended that all such additional features, embodiments and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention.

FIG. 1 sets forth a diagram of an embodiment of a system for providing electronic vouchers.

FIG. 2 sets forth a diagram of an alternate embodiment of a system for providing electronic vouchers using linked webpages.

FIG. 3 sets forth a diagram of another alternate embodiment of a system for providing electronic vouchers that goes through a reseller website.

FIG. 4 sets forth a diagram of a further embodiment of a system for providing electronic vouchers that a reseller website and linked webpages.

FIG. 5 sets forth a flow chart of a method for providing electronic vouchers using the system shown in FIG. 1.

FIG. 6 sets forth a flow chart of a method for providing electronic vouchers using the alternate embodiment of the system shown in FIG. 2.

FIG. 7 sets forth a flow chart of a method for providing electronic vouchers using the alternate embodiment of the system shown in FIG. 3.

FIG. 8 sets forth a flow chart of a method for providing electronic vouchers using the alternate embodiment of the system shown in FIG. 4.

FIG. 9 sets forth a flow chart showing additional method steps for communicating information, which steps can be used in the methods shown in FIGS. 5, 6, 7, or 8.

FIG. 10 sets forth a flowchart of a method of providing vouchers in accordance with a further embodiment of the invention.

### DETAILED DESCRIPTION OF THE PRESENTLY PREFERRED EMBODIMENT(S)

The embodiments of the current invention shown in the attached drawings provides a system and method for providing electronic vouchers that provides a buyer with a specific discount, on a specific product, for a specific time period, and is redeemable at a specific location. As used herein, the terms “product” and “products” refer to both goods and services.

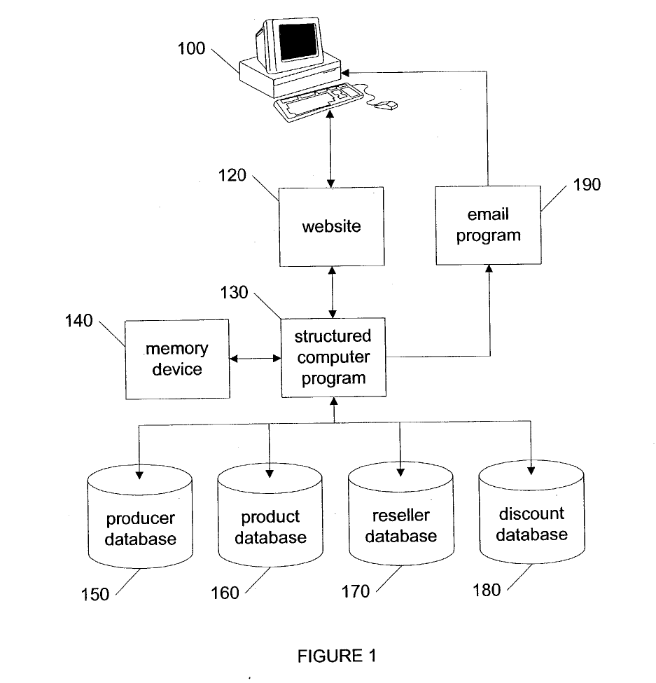

Referring now to the drawings in greater detail, in FIG. 1 there is illustrated an embodiment of the structure of the system for providing electronic vouchers.

In FIG. 1, a website 120 is accessed through the Internet (not shown) using a computing device 100 such as a computer, a handheld computing device, web-enabled call phone or personal digital assistant (PDA), or the like that allows an individual to access a website through the Internet. Alternatively, the website 120 can be accessed through a local area network, a wide area network, or any other network that allows access to a website by an individual.

A computer program 130 is executable through the website 120. The computer program 130 has a software routine to receive buyer information, such as by displaying a data entry screen or webpage through the website and receiving data entered, and has routines for permiting access to a producer database 150, a product database 160, a reseller database 170, and a discount database 180. The computer program 130 can be written using a suitable structured language, such as, C++ or Java.

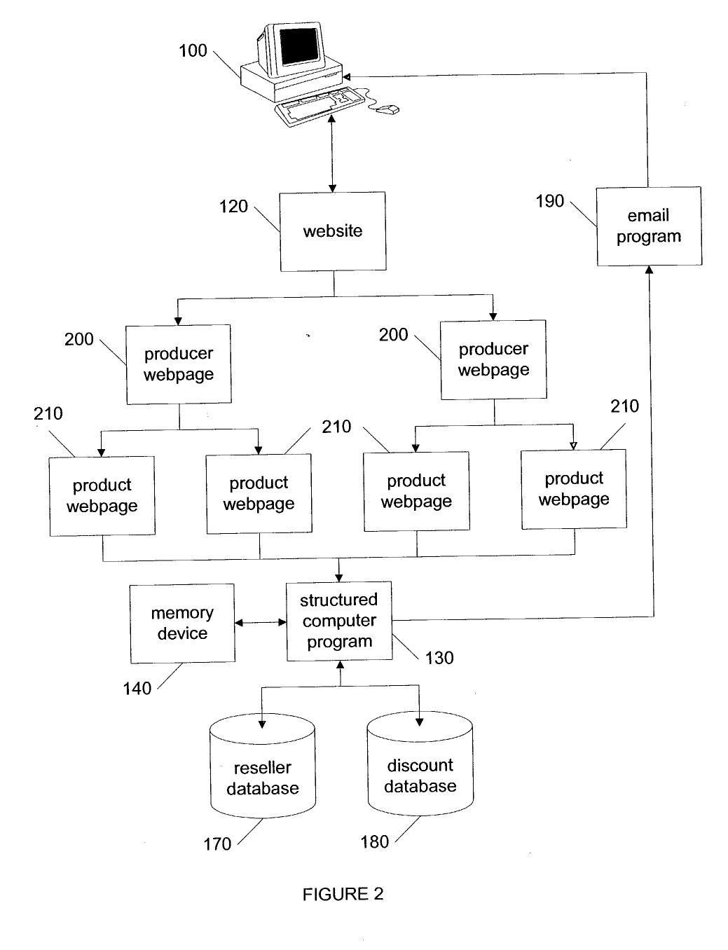

The producer database 150 contains a list of producers for which discounts are offered through the system. The producers in the producer database 150 do not have to be actual “producers” but can be any entities that provide in any manner any type of goods and/or services. If the system is being used for a single producer, the producer database 150 can contain a single entry for that particular producer or the producer database 150 can be removed from the system. The producer database 150 is used to identify the producers for which discounts are offered through the system and any suitable database structures or data formatting can be used for identifying the producers, such as the means described in the alternate embodiment shown in FIG. 2.

The product database 160 contains a list of products provided by each producer in the producer database 150. The products in the product database 160 do not have to be physical goods but can also be services provided by the producers. If the system is being used for a single product, the product database 160 can contain a single entry for that particular product or the product database 160 can be removed from the system. The product database 160 is used to identify the products provided by the producers and any suitable database structure or data formatting can be used for identifying the products can be used, such as the means described in the alternate embodiment shown in FIG. 2.

The reseller database 170 contains a list of the names and locations of the resellers that sell the products in the product database 160. The computer program 130 includes a software routine for selecting a reseller from the reseller database 170 based on the buyer information received.

The discount database 180 contains a list of the discounts that are available for each of the products in the product database 160, such as a cash value discount and an expiration date for each cash value discount. The discounts in the discount database 180 do not have to be cash value discounts but can be any incentives that are available such as free or discounted upgrades or options, free or discounted accessories, or any incentive that would have some value to a buyer. In addition, the discount database 180 may or may not contain expiration dates associated with the discounts depending on the discount program being used. If there is a single discount available, the discount database 180 can contain a single entry for that particular discount or the discount database 180 can be removed from the system. Alternatively, the discount database 180 can be removed from the system and the available discounts can be displayed on the website 120 rather than being selected through a discount database 180.

The computer program 130 also has access to a memory device 140 such as a computer hard drive or random access memory (RAM) where the computer program 130 can store information received, such as the producer and/or product selections and the buyer information.

Finally, the computer program 130 has access to an email program 190 with which it can communicate information to the computing device 100. The email program 190 can be a commercially available software program that runs on a personal computer (PC) or server and is capable of being interfaced to application software, such as the computer program 130. Alternatively, the email program 190 can be substituted by any means that allows the computer program 130 to communicate other information to the computing device 100 such as by displaying the information on the computing device 100, such as a Java script for generating a web page containing the information displayed by a web browser program resident on the computing device 100.

In FIG. 2 there is illustrated an alternate embodiment of the structure of the system for providing electronic vouchers that uses linked webpages rather than a producer database and a product database.

In FIG. 2, a website 120 is accessed through the Internet (not shown) using a computing device 100 as described above. The website 120 contains a list of the producers for which discounts are offered through the system and is linked to a producer webpage 200 for each producer listed. This can be done by making each producer name on the website 120 a hypertext link to the corresponding producer webpage 200, by using graphic buttons to link to the corresponding producer webpage 200, or any other method that would allow a buyer to select a producer on the website 120 and link to the corresponding producer webpage 200. If the system is being used for a single producer, the website 120 can contain that single producer or, as would be the case if the producer were using the system itself, the website 120 could contain a list of products as described below and the producer webpages 200 could be removed from the system.

Each producer webpage 200 contains a list of the products provided by that producer and is linked to a product webpage 210 for each product listed. This can be done by making each product name on the producer webpage 200 a hypertext link to the corresponding product webpage 210, by using graphic buttons or pictures of the products to link to the corresponding product webpage 210, or any other method that would allow a buyer to select a product on the producer webpage 200 and link to the corresponding product webpage 210. If the system is being used for a single product, the producer webpage 200 can contain that single product or the computer program 130 could be run directly through the website 120 and the product webpages 210 could be removed from the system.

The computer program 130 is executable through the product webpages 210. The computer program 130 has routines to receive buyer information, such as by displaying a data entry screen through the website and receiving data entered, and has access to a memory device 140, a reseller database 170, a discount database 180, and an email program 190. The computer program 130 includes a routine for selecting a reseller from the reseller database 170 based on the buyer information received above.

As described in connection with FIG. 1, the memory device 140 is a memory device such as a computer hard drive or RAM where information such as the buyer information can be stored, the reseller database 170 contains a list of the names and locations of the resellers that sell the products identified on each product webpage 210, the discount database 180 contains a list of the discounts that are available for each of the products identified on each product webpage 210, and the email program 190 provides communications with the computing device 100.

Alternatively, the discount database 180 can be omitted from the system and the available discounts can be displayed on the website 120, the producer webpage 200, or the product webpage 210 rather than being selected through a discount database 180.

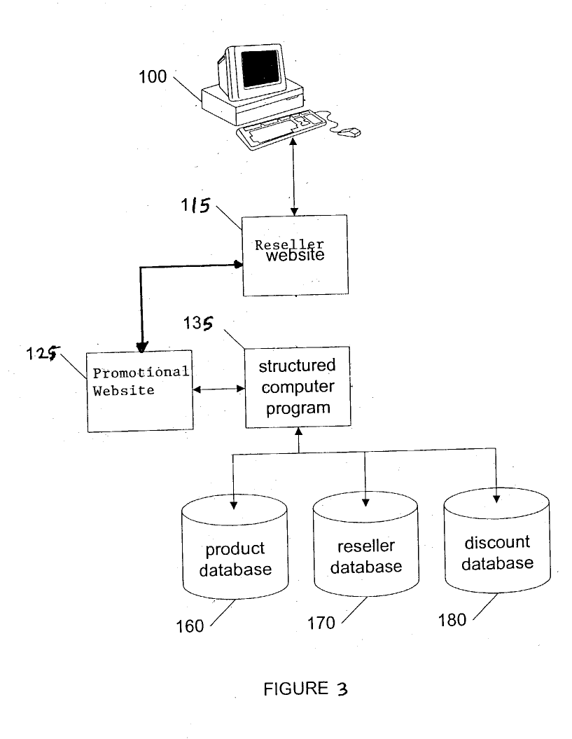

In FIG. 3 there is illustrated an alternate embodiment of the structure of the system for providing electronic vouchers where the system is accessed through a reseller website 115.

In FIG. 3, a reseller website 115 is accessed through the Internet (not shown) using a computing device 100 such as a computer, a handheld computing device or any other means that allows an individual to access a website through the Internet. Alternatively, the reseller website 115 can be accessed through a local area network, a wide area network, or any other method that allows access to a website by an individual.

The reseller website 115 is linked to a promotion website 125 which is maintained by a producer of products sold by the reseller. This can be done by listing the promotion and making the promotion name a hypertext link to the corresponding promotion website 125, by using graphic buttons to link to the corresponding promotion website 125, or any other method that would allow a buyer to select a promotion on the reseller website 115 and link to the corresponding promotion website 125. Alternatively, if the reseller sells the products from numerous producers, the reseller website 115 can be linked to a promotion website 125 for each of the producers. Similarly, in most instances, the promotion website 125 for a particular producer can be linked to the website of each reseller that sells the products of the producer.

A computer program 135 is executable through the promotion website 125. The computer program 135 has a routine to receive buyer information, such as by displaying and data entry screen through the website and receiving data entered, and has access to a product database 160, a reseller database 170, and a discount database 180.

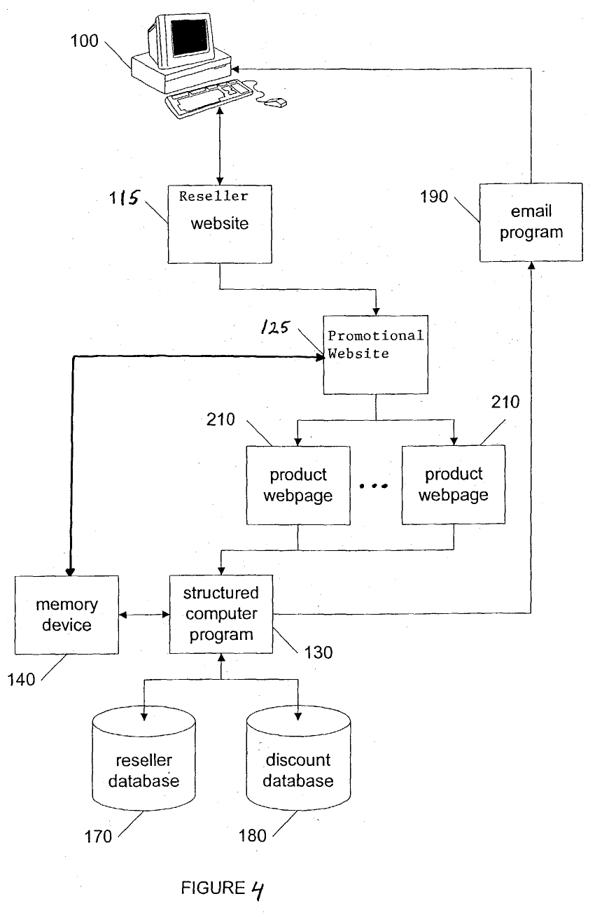

The product database 160 contains a list of products provided by the producer. The products in the product database 160 do not have to be physical goods but can also be services provided by the producer. If the system is being used for a single product, the product database 160 can contain a single entry for that particular product or the product database 160 can be removed from the system. The product database 160 is used to identify the products provided by the producer and any suitable database structure or data formats for identifying the products can be used, such as the means described in the alternate embodiment shown in FIG. 4.

The reseller database 170 contains a list of the names and locations of the resellers that sell the products in the product database 160. The computer program 135 includes a routine for verifying that the reseller that linked the buyer to the promotion website 125 is the correct reseller for the buyer based on the buyer information and for selecting a reseller from the reseller database 170 based on the buyer information if it is not. For example, assume that the reseller that linked the buyer to the promotion website was Reseller X, located in California, and the buyer entered their buyer information indicating that they are from Illinois. The computer program 135 would compare the location of the reseller to the location of the buyer and determine that Reseller X is not the correct reseller for a buyer in Illinois. The computer program 130 would then access the reseller database 170 and select a reseller(s) that is correct for a buyer located in Illinois. Alternatively, the computer program 130 could determine if the reseller that linked the buyer to the promotion website 125 is the correct reseller for the buyer based on a zip code entered by the buyer rather than the state.

The discount database 180 contains a list of the discounts that are available for each of the products as described above. Alternatively, the discount database 180 can be removed from the system and the available discounts can be displayed on the reseller website 115 or the promotion website 125 rather than being selected through a discount database 180.

The computer program 135 and promotion website 125 also have access to a memory device 140 such as a computer hard drive or RAM where the computer program 135 and/or promotion website 125 can store information received, such as the reseller that the buyer linked from, the product selection, and the buyer information.

Finally, the computer program 135 has access to an email program 190 with which it can communicate information to the computing device 100 as described above in connection with FIG. 1.

In FIG. 4 there is illustrated an alternate embodiment of the structure of the system for providing electronic vouchers where the system is accessed through a reseller website and that uses linked webpages rather than a product database.

In FIG. 4, a reseller website 115 is accessed through the Internet (not shown) using a computing device 100 as described above. The reseller website 115 is linked to a promotion website 125 which is maintained by a producer of products sold by the reseller. This can be done by listing the promotion and making the promotion name a hypertext link to the corresponding promotion website 125, by using graphic buttons to link to the corresponding promotion website 125, or any other method that would allow a buyer to select a promotion on the reseller website 115 and link to the corresponding promotion website 125. Alternatively, if the reseller sells products from numerous producers, the reseller website 115 can be linked to a promotion website 125 for each of the producers. Similarly, in most instances, the promotion website 125 for a particular producer will most likely be linked to the website of each reseller that sells the products of the producer.

The promotion website 125 contains a list of the products provided by the producer and is linked to a product webpage 210 for each product listed. This can be done by making each product name on the promotion website 125 a hypertext link to the corresponding product webpage 210, by using graphic buttons or pictures of the products to link to the corresponding product webpage 210, or any other method that would allow a buyer to select a product on the promotion website 125 and link to the corresponding product webpage 210.

A computer program 135 is executable through the product webpages 210. The computer program 130 has a means to receive buyer information, such as by displaying a data entry screen through the promotion website 125 and receiving data entered, and has access to a reseller database 170 and a discount database 180.

The reseller database 170 contains a list of the names and locations of the resellers that sell the products provided by the producer. As described above, the computer program 130 includes a means for verifying that the reseller that linked the buyer to the promotion website 125 is the correct reseller for the buyer based on the buyer information, and for selecting a reseller from the reseller database 170 based on the buyer information if it is not.

The discount database 180 contains a list of the discounts that are available for each of the products as described above. Alternatively, the discount database 180 can be removed from the system and the available discounts can be displayed on the promotion website 125 or on a product webpage 210 rather than being selected through a discount database 180.

In addition, the computer program 135 and promotion website 125 have access to a memory device 140, such as a computer hard drive or RAM, as described above and the computer program 130 has access to an email program 190 as described above.

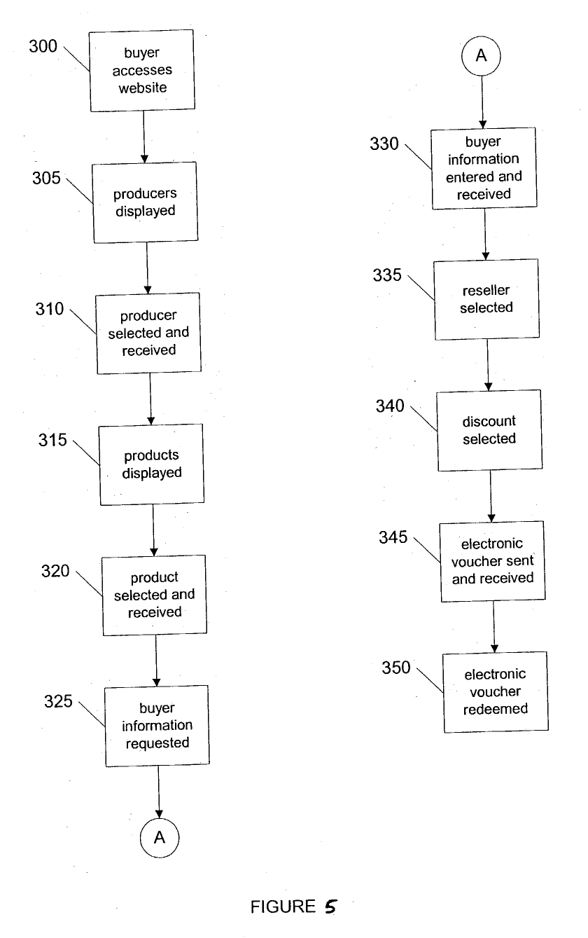

In FIG. 5 there is illustrated an embodiment of a method for providing electronic vouchers using the system shown in FIG. 1.

Step 1. Buyer Accesses Website.

At 300, a buyer accesses the website 120 via the Internet using the computing device 100. As described above, the buyer could also access the website 120 via a local area network, a wide area network, or any other method that allows access to a website by an individual.

Step 2. Producers Displayed.

At 305, the computer program 130 is executed through the website 120 and a list of producers from the producer database 150 is displayed through the website 120. If there is only a single producer, the buyer could be shown a list of producers that includes only the single producer or Steps 2 and 3 can be skipped and only a list of products from the single producer would be displayed as in Step 4.

Step 3. Producer Selected and Received.

At 310, the buyer selects, from the list of producers displayed, the producer the buyer is interested in. The computer program 130 then receives the producer selection and stores the producer selection in the memory device 140.

Step 4. Products Displayed.

At 315, a list of relevant products from the product database 160 is displayed through the website 120. Based on the producer selection from Step 3, the list of the products from the product database 160 are those that are provided by the producer and have discounts available. If only a single product is available, the buyer could be shown a list of products that includes only the single product or Steps 4 and 5 can be skipped and the buyer information entry screen displayed as in Step 6.

Step 5. Product Selected and Received.

At 320, the buyer selects, from the list of products displayed, the product that the buyer is interested in. The computer program 130 then receives the product selection and stores the product selection in the memory device 140.

Step 6. Buyer Information Requested.

At 325, a buyer information entry screen is displayed through the website 120 and requests that the buyer enter the zip code where he is located and an email address. Alternatively, the buyer information entry screen could request that the buyer provide as little or as much information as is needed to determine his/her geographic location. For example, the buyer information entry screen could request only the zip code where the buyer is located, in order to select the appropriate reseller as described in Step 8 below. In addition, the buyer information entry screen could request additional information such as the buyer's name, address, gender, occupation, or the like, if collecting information on the buyers that are using the system is desired.

Step 7. Buyer Information Entered and Received.

At 330, the buyer enters a zip code and an email address, or any other buyer information that is requested, and submits this information. The computer program 130 then receives the zip code and email address, or any buyer information requested, and stores the buyer information in the memory device 140.

Alternatively, Steps 6 and 7 can be performed at any point during the process prior to the reseller being selected as described in Step 8 below. For example, the buyer information could be requested, entered, and received right after the buyer accesses the website 120 in Step 1, before the buyer can go any further into the process.

Step 8. Reseller Selected.

At 335, the computer program 130 selects a reseller(s) from the reseller database 170 based on the zip code entered by the buyer. The computer program 130 selects the reseller(s) that is located closest to the buyer based on the zip code entered by the buyer. Alternatively/Additionally, program 130 can select a reseller having a distribution territory in which the buyer resides or is closest to.

Alternatively, the reseller(s) can be selected at some other time in the process and Step 8 can be skipped. For example, the buyer could be instructed to bring the voucher they receive to a producer's location at a trade exhibition or show, such as a boat show. When the buyer brings the voucher to the show, the producer representative would locate the reseller based on the buyer's zip code and inform the buyer of the reseller(s) where they can redeem the voucher.

In addition, the reseller does not have to be selected based on a zip code. The reseller can be selected based on an address or on any other criteria that would allow the computer program 130 to select the appropriate reseller for the buyer to go to.

Step 9. Discount Selected.

At 340, the computer program 130 selects a cash value discount and an expiration date from the discount database 180 based on the product selected by the buyer. Alternatively, the discounts in the discount database 180 could be any incentives that are available for each of the products, such as free or discounted upgrades or options, free or discounted accessories, or any discount that would have some value to the buyer. In addition, the discounts available do not have to come from a discount database or selected at this point in the process. For example, if there is a single discount that is available for all of a particular producer's products, the discount could be listed with the producers in Step 2, with the list of products in Step 4, when the buyer information screen is displayed in Step 6, or at any other point during the process. If the discount is communicated to the buyer during the process, rather than being selected from a discount database, Step 9 can be skipped and electronic voucher sent as described in Step 10 below.

Step 10. Electronic Voucher Sent and Received.

At 345, the computer program 130 sends an electronic voucher to the buyer at the email address provided by the buyer via the email program 190. The buyer then receives the electronic voucher as an email message at the email address provided. The electronic voucher contains the producer and product selected by the buyer, the cash value discount, the expiration date, and the name and location of the reseller(s) where the electronic voucher can be redeemed. Alternatively, the computer program 130 could display the electronic voucher, or the information that would be contained on the electronic voucher, to the buyer through the website 120 or by any other means of communicating this information to the buyer such as by fax or by telephone. In addition, the electronic voucher, or the information communicated to the buyer, does not have to include all of the information listed above but can contain any information desired. For example, if the discount is displayed at some point during the process, as described in Step 9 above, then the discount does not have to be included on the electronic voucher. Similarly, since the buyer knows what producer and product they have selected, the producer and product selected also do not have to be included on the electronic voucher. Finally, if the reseller is selected after the voucher is sent and received, such as at a boat show as described in Step 8 above, the reseller does not have to be included on the electronic voucher.

Step 11. Electronic Voucher Redeemed.

At 350, the buyer prints the electronic voucher received from the computer program 130 and brings it to the reseller listed for redemption. The printed electronic voucher can only be redeemed at the reseller listed, for the product listed, and prior to the expiration date listed.

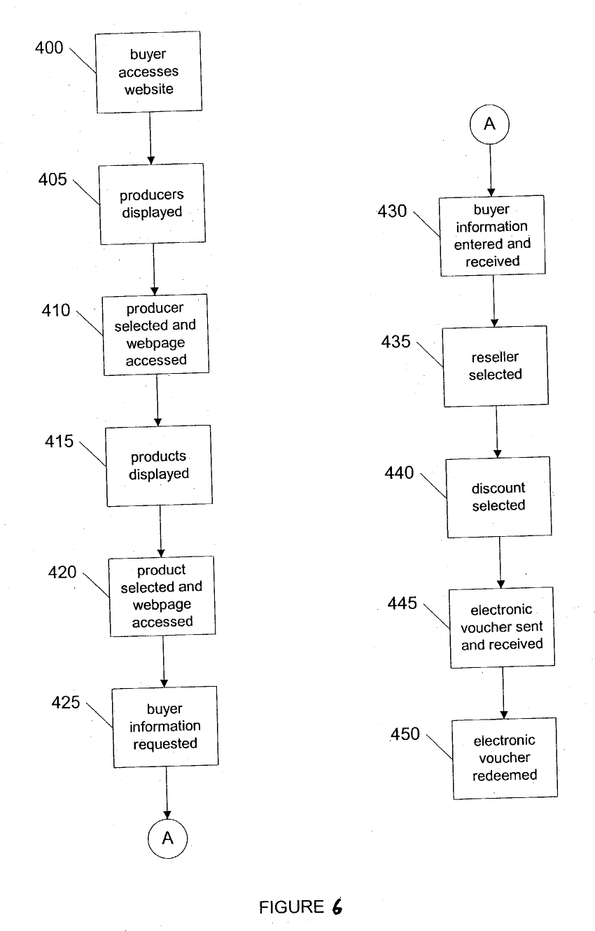

In FIG. 6 there is illustrated method for providing electronic vouchers using the system shown in FIG. 2.

Step 1. Buyer Accesses Website.

At 400, a buyer accesses the website 120 via the Internet using the computing device 100. As described above, the buyer could also access the website 120 via a local area network, a wide area network, or any other method that allows access to a website by an individual.

Step 2. Producers Displayed.

At 405, a list of producers for which discounts are offered through the system are displayed on the website 120. Each producer listed will have a link to a producer webpage 200 for that particular producer. This can be done by making each producer name a hypertext link to the corresponding producer webpage 200, by using graphic buttons to link to the corresponding producer webpage 200, or any other method that would allow the buyer to select a producer on the website 120 and link to the corresponding producer webpage 200. If there is only a single producer, a list of producers that includes only the single producer could be shown or Steps 2 and 3 can be skipped.

Step 3. Producer Selected and Webpage Accessed.

At 410, the buyer selects, from the list of producers displayed, the producer the buyer is interested in by clicking on the link for that producer. The website 120 then links to the producer webpage 200 for that producer and the producer webpage 200 is displayed.

Step 4. Products Displayed.

At 415, a list of products provided by the producer selected is displayed on the producer webpage 200. Each product listed will have a link to a product webpage 210 for that particular product. This can be done by making each product name a hypertext link to the corresponding product webpage 210, by using graphic buttons or pictures of the products to link to the corresponding product webpage 210, or any other method that would allow the buyer to select a product on the producer webpage 200 and link to the corresponding product webpage 210. If only a single product is available, a list of products that includes only the single product could be shown or Steps 4 and 5 can be skipped.

Step 5. Product Selected and Webpage Accessed.

At 420, the buyer selects, from the list of products displayed, the product that the buyer is interested in by clicking on the link for that product. The producer webpage 200 then links to the product webpage 210 for that product and the product webpage 210 is displayed.

Step 6. Buyer Information Requested.

At 425, various information regarding the product selected, such as the name of the product, specifications regarding the product, a picture of the product, etc., is displayed on the product webpage 210 and the buyer is requested to enter a zip code and an email address. Alternatively, any desired information regarding the product could be displayed on the product webpage 210 or no information regarding the product could be displayed and the buyer only requested to enter the buyer information. In addition, the buyer could also be requested to enter any additional buyer information that is believed useful such as name, address, gender, occupation, etc. Alternatively, the product webpage 210 could contain a link to another webpage, such as the buyer information entry screen described above, to request and receive the buyer information.

Step 7. Buyer Information Entered and Received.

At 430, the buyer enters a zip code and an email address, and any other additional buyer information that is requested, and submits this information. The product webpage 210 accesses the computer program 130 and sends the zip code and email address, and any other additional buyer information entered, to the computer program 130, which stores the information in the memory device 140.

Alternatively, Steps 6 and 7 can be performed at any point during the process prior to the reseller being selected in Step 8. For example, the buyer information could be requested, entered, and received right after the buyer accesses the website 120 in Step 1, before the buyer can go any further into the process.

Step 8. Reseller Selected.

At 435, the computer program 130 selects a reseller(s) from the reseller database 170 based on the zip code entered by the buyer in the memory device 140. The computer program 130 selects the reseller(s) that is located closest to the buyer based on the zip code entered by the buyer.

Alternatively, the reseller(s) can be selected at some other time in the process and Step 8 can be skipped. For example, the buyer could be instructed to bring the voucher they receive to a producer's location at a boat show. When the buyer brings the voucher to the boat show, the producer representative would locate the reseller based on the buyer's zip code and inform the buyer of the reseller(s) where they can redeem the voucher.

In addition, the reseller does not have to be selected based on a zip code. The reseller can be selected based on an address or on any other criteria that would allow the computer program 130 to select the appropriate reseller for the buyer to go to.

Step 9. Discount Selected.

At 440, the computer program 130 selects a cash value discount and an expiration date from the discount database 180 based on the product selected by the buyer. Alternatively, the discounts in the discount database 180 could be any incentives that are available for each of the products such as free or discounted upgrades or options, free or discounted accessories, or any discount that would have some value to the buyer. In addition, the discounts available do not have to come from a discount database or selected at this point in the process. For example, if there is a single discount that is available for all of a particular producer's products, the discount could be listed with the producers in Step 2, with the list of products in Step 4, when the products are displayed in Step 6, or at any other point during the process. If the discount is communicated to the buyer during the process, rather than being selected from a discount database, Step 9 can be skipped.

Step 10. Electronic Voucher Sent and Received.

At 445, the computer program 130 sends an electronic voucher to the buyer at the email address provided by the buyer via the email program 190. The buyer then receives the electronic voucher as an email message at the email address provided. The electronic voucher contains the producer and product selected by the buyer, the cash value discount, the expiration date, and the name and location of the reseller(s) where the electronic voucher can be redeemed. Alternatively, the computer program 130 could display the electronic voucher, or the information that would be contained on the electronic voucher, to the buyer through the website 120 or by any other means of communicating this information to the buyer such as by fax or by telephone. In addition, the electronic voucher, or the information communicated to the buyer, does not have to include all of the information listed above but can contain any information desired. For example, if the discount is displayed at some point during the process, as described in Step 9 above, then the discount does not have to be included on the electronic voucher. Similarly, since the buyer knows what producer and product they have selected, the producer and product selected also do not have to be included on the electronic voucher. Finally, if the reseller is selected after the voucher is sent and received, such as at a boat show as described in Step 8 above, the reseller does not have to be included on the electronic voucher.

Step 11. Electronic Voucher Redeemed.

At 450, the buyer prints the electronic voucher received from the computer program 130 and brings it to the reseller listed for redemption. The printed electronic voucher can only be redeemed at the reseller listed, for the product listed, and prior to the expiration date listed.

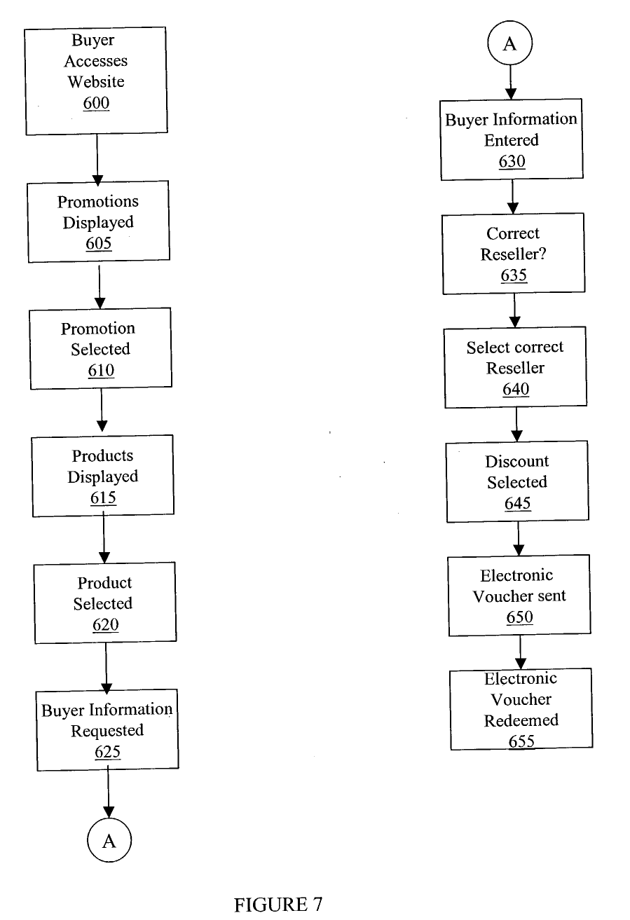

In FIG. 7 there is illustrated a method for providing electronic vouchers using the system shown in FIG. 3.

Step 1. Buyer Accesses Reseller Website.

At 600, a buyer accesses a reseller website 115 via the Internet using the computing device 100. As described above, the buyer could also access the reseller website 115 via a local area network, a wide area network, or any other method that allows access to a website by an individual.

Step 2. Promotions Displayed.

At 605, the promotions available through the system for various producers are displayed on the reseller website 115. Each promotion listed will have a link to a promotion website 125 for that particular promotion, which is maintained by a producer of products sold by the reseller. This can be done by making each promotion name a hypertext link to the corresponding promotion website 125, by using graphic buttons to link to the corresponding promotion website 125, or any other method that would allow the buyer to select a promotion on the reseller website 115 and link to the corresponding promotion website 125.

Step 3. Promotion Selected and Received.

At 610, the buyer selects, from the list of promotions displayed, the promotion the buyer is interested in by clicking on the link for that promotion. The reseller website 115 then links to the promotion website 125 for that promotion, the promotion website 125 is displayed, and the reseller from which the promotion website 125 was accessed is determined and stored in the memory device 140.

Step 4. Products Displayed.

At 615, the computer program 130 is executed through the promotion website 125 and a list of products from the product database 160 is displayed through the promotion website 125. Based on the promotion selected in Step 3, the list of the products from the product database 160 are those that are provided by the producer and have discounts available. If only a single product is available, the buyer could be shown a list of products that includes only the single product or Steps 4 and 5 can be skipped and the buyer information entry screen displayed as in Step 6.

Step 5. Product Selected and Received.

At 620, the buyer selects, from the list of products displayed, the product that the buyer is interested in. The computer program 130 then receives the product selection and stores the product selection in the memory device 140.

Step 6. Buyer Information Requested.

At 625, a buyer information entry screen is displayed through the promotion website 125 and requests that the buyer enter the zip code where he is located and an email address. Alternatively, the buyer information entry screen could request that the buyer provide as little or as much information as is believed useful. For example, the buyer information entry screen could request only the zip code where the buyer is located, in order to identify the correct reseller or could request additional information such as the buyer's name, address, gender, occupation, etc., if desired.

Step 7. Buyer Information Entered and Received.

At 630, the buyer enters a zip code and an email address, or any buyer information that is requested, and submits this information. The computer program 130 then receives the zip code and email address, or any buyer information requested, and stores the buyer information in the memory device 140.

Alternatively, Steps 6 and 7 can be performed at any point during the process prior to the reseller being selected as described in Step 8 below. For example, the buyer information could be requested, entered, and received right after the buyer accesses the promotion website 125, before the buyer can go any further into the process.

Step 8. Reseller Checked and Selected.

At 635, the computer program 130 determines if the reseller that linked the buyer to the promotion website 125 is the correct reseller. The computer program 130 does this by comparing the zip code, or any other useful identifying information, entered by the buyer to the territorial restrictions of the reseller. For example, if the reseller that linked the buyer to the promotion website 125 is granted the right to sell the products of the producer in Illinois, the computer program 130 would verify that the zip code entered by the buyer is in Illinois. If the reseller that linked the buyer to the promotion website 125 is the correct reseller, the process continues with Step 9.

If the reseller that linked the buyer to the promotion website 125 is not the correct reseller, at 640, the computer program 130 selects a reseller(s) from the reseller database 170 based on the zip code entered by the buyer. The computer program 130 selects the reseller(s) that is located closest to the buyer based on the zip code entered by the buyer or based on any other territorial restrictions the producer may have.

Alternatively, the reseller does not have to be selected based on a zip code. The reseller can be selected based on an address or on any other criteria that would allow the computer program 130 to select the appropriate reseller for the buyer to go to.

Step 9. Discount Selected.

At 645, the computer program 130 selects a cash value discount and an expiration date from the discount database 180 based on the product selected by the buyer. Alternatively, the discounts in the discount database 180 could be any incentives that are available for each of the products such as free or discounted upgrades or options, free or discounted accessories, or any discount that would have some value to the buyer. In addition, the discounts available do not have to come from a discount database or selected at this point in the process. For example, if there is a single discount that is available for all of a particular producer's products, the discount could be listed on the reseller website 115, the promotion website 125, when the buyer information screen is displayed, or at any other point during the process. If the discount is communicated to the buyer during the process, rather than being selected from a discount database, Step 9 can be skipped and the electronic voucher sent as described in Step 10 below.

Step 10. Electronic Voucher Sent and Received.

At 650, the computer program 130 sends an electronic voucher to the buyer at the email address provided by the buyer via the email program 190. The buyer then receives the electronic voucher as an email message at the email address provided. The electronic voucher contains the product selected by the buyer, the cash value discount, and the expiration date, and the name and location of the reseller(s) where the electronic voucher can be redeemed. The reseller(s) could be the reseller that linked the buyer to the promotion website 125, if that reseller was correct, or could be the reseller selected at 640. Alternatively, the computer program 130 could display the electronic voucher, or the information that would be contained on the electronic voucher, to the buyer through the promotion website 125 or by any other means of communicating this information to the buyer such as by fax or by telephone. In addition, the electronic voucher, or the information communicated to the buyer, does not have to include all of the information listed above but can contain any information desired. For example, if the discount is displayed at some point during the process, as described in Step 9 above, then the discount does not have to be included on the electronic voucher. Similarly, since the buyer knows what product they selected, the product selected also does not have to be included on the electronic voucher. Finally, if the reseller is selected after the voucher is sent and received, such as at a boat show as described in Step 8 above, the reseller does not have to be included on the electronic voucher.

Step 11. Electronic Voucher Redeemed.

At 655, the buyer prints the electronic voucher received from the computer program 130 and brings it to the reseller listed for redemption. The printed electronic voucher can only be redeemed at the reseller listed, for the product listed, and prior to the expiration date listed.

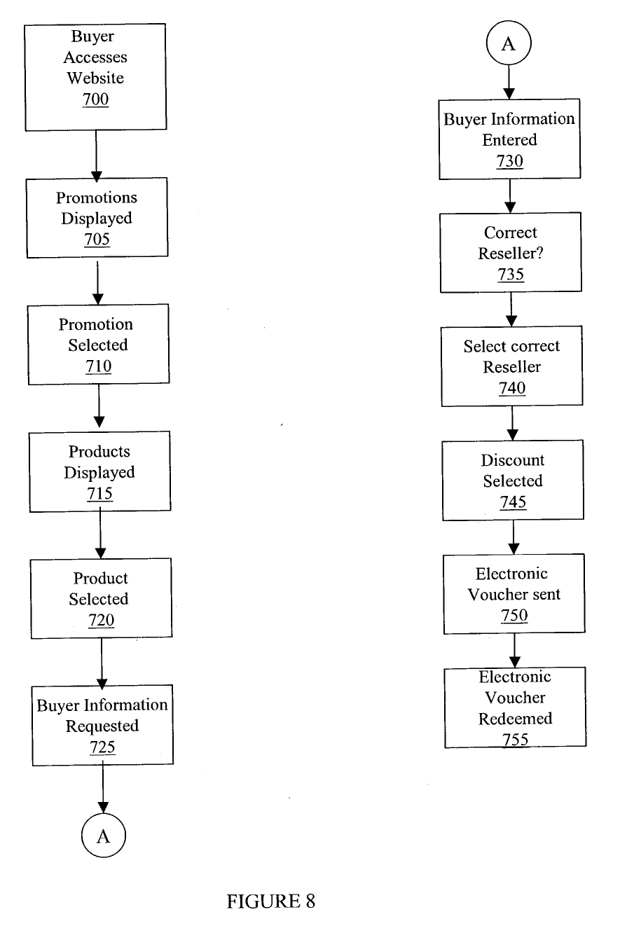

In FIG. 8 there is illustrated an alternate embodiment of the method for providing electronic vouchers using the alternate embodiment of the system shown in FIG. 4.

Step 1. Buyer Accesses Reseller Website.

At 700, a buyer accesses a reseller website 115 via the Internet using the computing device 100 as described above.

Step 2. Promotions Displayed.

At 705, the promotions available through the system for various producers are displayed on the reseller website 115. Each promotion listed will have a link to a promotion website 125 for that particular promotion, which is maintained by a producer of products sold by the reseller. This can be done by making each promotion name a hypertext link to the corresponding promotion website 125, by using graphic buttons to link to the corresponding promotion website 125, or any other method that would allow the buyer to select a promotion on the reseller website 115 and link to the corresponding promotion website 125.

Step 3. Promotion Selected and Received.

At 710, the buyer selects, from the list of promotions displayed, the promotion the buyer is interested in by clicking on the link for that promotion. The reseller website 115 then links to the promotion website 125 for that promotion, the promotion website 125 is displayed, and the reseller from which the promotion website 125 was accessed is stored in the memory device 140.

Step 4. Products Displayed.

At 715, a list of products provided by the producer, that have discounts available through the promotion, are displayed on the promotion website 125. Each product listed will have a link to a product webpage 210 for that particular product. This can be done by making each product name a hypertext link to the corresponding product webpage 210, by using graphic buttons or pictures of the products to link to the corresponding product webpage 210, or any other method that would allow the buyer to select a product on the promotion website 125 and link to the corresponding product webpage 210. If only a single product is available, a list of products that includes only the single product could be shown or Steps 4 and 5 can be skipped.

Step 5. Product Selected and Webpage Accessed.

At 720, the buyer selects, from the list of products displayed, the product that the buyer is interested in by clicking on the link for that product. The promotion website 125 then links to the product webpage 210 for that product and the product webpage 210 is displayed.

Step 6. Buyer Information Requested.

At 725, various information regarding the product selected, such as the name of the product, specifications regarding the product, a picture of the product, etc., is displayed on the product webpage 210 and the buyer is requested to enter a zip code and an email address. Alternatively, any desired information regarding the product could be displayed on the product webpage 210 or no information regarding the product could be displayed and the buyer only requested to enter the buyer information. In addition, the buyer could also be requested to enter any additional buyer information that is believed useful such as name, address, gender, occupation, etc. Alternatively, the product webpage 210 could contain a link to another webpage, such as the buyer information entry screen described above, to request and receive the buyer information.

Step 7. Buyer Information Entered and Received.

At 730, the buyer enters a zip code and an email address, or any buyer information that is requested, and submits this information. The product webpage 210 accesses the computer program 130 and sends the zip code and email address, or any other buyer information entered, to the computer program 130, which stores the information in the memory device 140.

Alternatively, Steps 6 and 7 can be performed at any point during the process prior to the reseller being selected as described in Step 8 below. For example, the buyer information could be requested, entered, and received right after the buyer accesses the promotion website 125, before the buyer can go any further into the process.

Step 8. Reseller Checked and Selected.

At 735, the computer program 130 determines if the reseller that linked the buyer to the promotion website 125 is the correct reseller. The computer program 130 does this by comparing the zip code, or any other useful identifying information such as the state of residence, entered by the buyer to the territorial restrictions of the reseller. For example, if the reseller that linked the buyer to the promotion website 125 is granted the right to sell the products of the producer in Illinois, the computer program 130 would verify that the zip code entered by the buyer is in Illinois. If the reseller that linked the buyer to the promotion website 125 is the correct reseller, the process continues with Step 9.

If the reseller that linked the buyer to the promotion website 125 is not the correct reseller, at 740, the computer program 130 selects a reseller(s) from the reseller database 170 based on the zip code entered by the buyer. The computer program 130 selects the reseller(s) that is located closest to the buyer based on the zip code entered by the buyer or based on any other territorial restrictions the producer may have.

Alternatively, the reseller does not have to be selected based on a zip code. The reseller can be selected based on an address or on any other criteria that would allow the computer program 130 to select the appropriate reseller for the buyer to go to.

Step 9. Discount Selected.

At 745, the computer program 130 selects a cash value discount and an expiration date from the discount database 180 based on the product selected by the buyer. Alternatively, the discounts in the discount database 180 could be any incentives that are available for each of the products such as free or discounted upgrades or options, free or discounted accessories, or any discount that would have some value to the buyer. In addition, the discounts available do not have to come from a discount database or selected at this point in the process. For example, if there is a single discount that is available for all of a particular producer's products, the discount could be listed on the reseller website 115, the promotion website 125, when the buyer information screen is displayed, or at any other point during the process. If the discount is communicated to the buyer during the process, rather than being selected from a discount database, Step 9 can be skipped and the electronic voucher sent as described in Step 10 below.

Step 10. Electronic Voucher Sent and Received.

At 750, the computer program 130 sends an electronic voucher to the buyer at the email address provided by the buyer via the email program 190. The buyer then receives the electronic voucher as an email message at the email address provided. The electronic voucher contains the product selected by the buyer, the cash value discount, the expiration date, and the name and location of the reseller(s) where the electronic voucher can be redeemed. The reseller(s) could be the reseller that linked the buyer to the promotion website 125, if that reseller was correct, or could be the reseller selected at 740. Alternatively, the computer program 130 could display the electronic voucher, or the information that would be contained on the electronic voucher, to the buyer through the promotion website 125 or by any other means of communicating this information to the buyer such as by fax or by telephone. In addition, the electronic voucher, or the information communicated to the buyer, does not have to include all of the information listed above but can contain any information desired. For example, if the discount is displayed at some point during the process, as described in Step 9 above, then the discount does not have to be included on the electronic voucher. Similarly, since the buyer knows what product they selected, the product selected also does not have to be included on the electronic voucher. Finally, if the reseller is selected after the voucher is sent and received, such as at a boat show as described in Step 8 above, the reseller does not have to be included on the electronic voucher.

Step 11. Electronic Voucher Redeemed.

At 755, the buyer prints the electronic voucher received from the computer program 130 and brings it to the reseller listed for redemption. The printed electronic voucher can only be redeemed at the reseller listed, for the product listed, and prior to the expiration date listed.

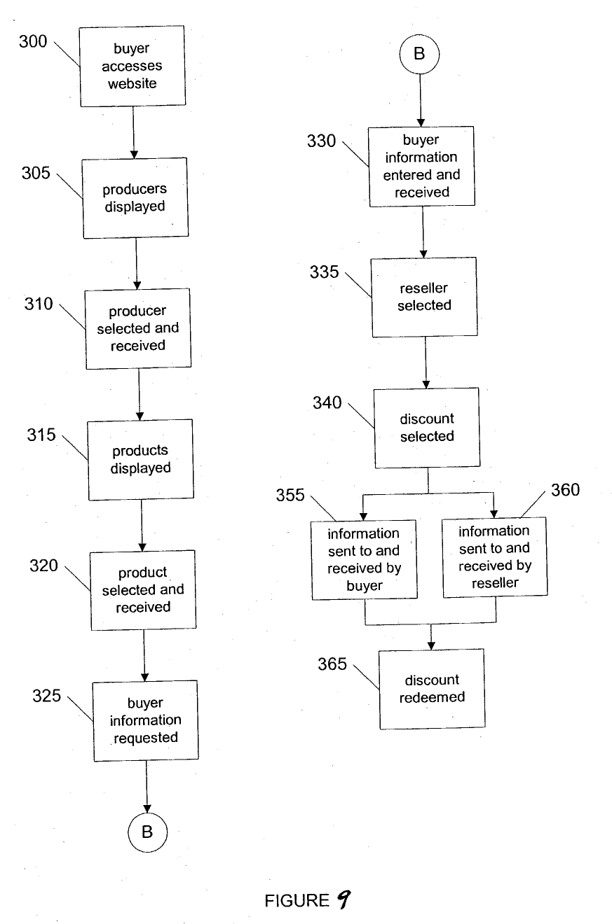

In FIG. 9 there is illustrated a method for communicating the information, such as the reseller and discount, and for redeeming the discount that can be used with any of the method shown in FIGS. 5, 6, 7, or 8. Referring to FIG. 9, a first set of information, such as the reseller, product selection, and discount, are communicated to the buyer and a second set of information, such as the product selection, discount, and buyer information, are communicated to the reseller. Therefore, the buyer does not have to print an electronic voucher and bring it to the reseller, but only has to show up at the reseller and give the reseller their information in order to redeem the discount. In this alternate method, only the communication of the information and the redemption of the discount, Steps 10 and 11, are different and Steps 1-9 are identical to those in the embodiments described above. In this alternate method, Steps 10 and 11 would be as follows.

Step 10. Information Sent to Buyer and Reseller.

At 355, the computer program 130 sends the product selected, the cash value discount, the expiration date, and the reseller(s) to the buyer at the email address provided by the buyer via the email program 190. Alternatively, as described above, the computer program 130 could display the information to the buyer through the website 120, or the promotion website 125 depending on which embodiment is used, or by any other means of communicating the information to the buyer such as by fax or telephone. In addition, the information communicated to the buyer does not have to include all of the information listed above but can contain any information desired as long as the buyer is informed of the reseller that they must go to and preferably what identifying information will be required to redeem the discount. For example, if the discount is displayed at some point during the process, as described in Step 9, then the discount does not have to be communicated to the buyer at this point. Similarly, since the buyer knows what product they have selected, the product selected also do not have to be communicated at this point.

At 360, the computer program 130 sends the product selection, the cash value discount, the expiration date, and the buyer information to the reseller(s). This information can be sent to the reseller(s) by email, by fax, by telephone, or by any other method that would communicate this information to the reseller(s) quickly and accurately. In addition, the information sent to the reseller(s) does not have to include all of the information listed above but can contain any information desired as long as the reseller is informed of what discount is being given and the identifying information for the buyer the discount is to be given to.

Step 11. Discount Redeemed.

At 365, the buyer goes to the reseller identified in Step 10 above and provides the reseller with the buyer information. Based on the buyer information, the reseller can then find the product the buyer is interested in, the cash value discount to be provided, and the expiration date of the discount from the information received in Step 10. The discount provided can only be redeemed by the buyer listed, for the product listed, and prior to the expiration date listed.

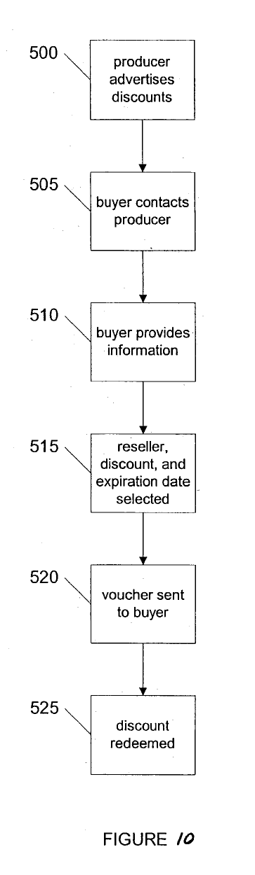

Although the above embodiments of the method of the current invention both use a website, it is not necessary that a website be used in order to practice the current invention. In FIG. 10 there is illustrated an alternate embodiment of the method of the current invention that addresses the same needs and solves the same problems but does not use a website.

Step 1. Producer Advertises Discounts.

At 500, a producer advertises the discounts that it is making available to buyers. The advertisement can be a newspaper or magazine add, a television or radio commercial, or any other method to communicate the available discounts to buyers. Preferably, this advertisement would include a list of the products for which discounts are available and information on how to contact the producer to receive the discount. Alternatively, the advertisement could also include the discounts that are available for each product, the expiration date of each offered discount, a statement that the discounts are only available at certain resellers, etc.

Step 2. Buyer Contacts Producer.

At 505, the buyer contacts the producer through whatever means were identified in the advertisement. Preferably, the buyer would call a telephone number identified in the advertisement. Alternatively, the buyer may also return a postcard, send an email, or somehow otherwise communicate to the producer that they are interested in the discount.

Step 3. Buyer Provides Information.

At 510, the buyer provides buyer information to the producer. The buyer information may include, but is not limited to, the product the buyer is interested in, the buyer's address and zip code, and any other information the producer may be interested in. The buyer information can be provided over the telephone, on a return postcard, or in an email as stated in Step 2 above.

Step 4. Reseller, Discount, and Expiration Date Selected.

At 515, the producer selects a specific reseller, discount and expiration date based on the product identified by the buyer and the address and/or zip code provided by the buyer. The information selected by the producer could also be just the reseller and discount if the discount does not have any expiration date, or the expiration date was communicated in the advertisement in Step 1, or could also be just the reseller if the discount and/or expiration date were communicated in the advertisement in Step 1. The reseller selected will be the reseller that is geographically located closest to the buyer based on the address and/or zip code provided by the buyer. The reseller, discount, and expiration date can be obtained by the producer in a variety of ways such as through printed tables which list this information, computerized databases, or any other means which would allow the producer to keep track of the products available, the resellers that sell these products and their locations, the discounts available on each product, and the expiration dates of each discount. In the preferred embodiment of the invention, the discount provided is a cash value discount that can be used towards the purchase of the product. In alternate embodiments of the invention, the discount can be free or discounted upgrades or options, free or discounted accessories, or any discount that would have some value to the buyer.

Step 5. Voucher Sent to Buyer.

The producer sends a voucher to the buyer that contains the product selected by the buyer, the discount available on that product, the expiration date of the discount, and the reseller at which the voucher can be redeemed. As stated above, the information on the voucher could also be just the reseller and discount if the discount does not have any expiration date, or the expiration date was communicated in the advertisement in Step 1, or could also be just the reseller if the discount and/or expiration date were communicated in the advertisement in Step 1. The voucher could be communicated to the buyer in any manner, including, but not limited to, via email, postal mail, fax, etc. In addition, the producer could give the information that would be communicated on the voucher to the buyer over the phone.

Step 6. Discount Redeemed.

The buyer brings the voucher to the reseller listed on the voucher for redemption. The voucher can only be redeemed at the reseller listed, for the product listed, and prior to the expiration date listed. In addition, if the information from the voucher was given to the buyer over the phone, the buyer would only need to go to the specified reseller and provide the reseller with the information they were given rather than having a voucher.

The foregoing description of the embodiments of the invention have been presented for purposes of illustration and description, and are not intended to be exhaustive or to limit the invention to the precise forms disclosed. The descriptions were selected to best explain the principles of the invention and their practical application to enable those skilled in the art to best utilize the invention in various embodiments and various modifications as are suited to the particular use contemplated. It is intended that the scope of the invention not be limited by the specification, but be defined by the claims set forth below.

I claim:

1. A system for providing an electronic voucher to a computing device, comprising:
a reseller website, accessible by the computing device via a network;
a promotion website linked to the reseller website;
a computer program, executable through the promotion website, having the ability to receive buyer information, determine if a linking reseller is correct based on the buyer information, and to select a reseller based on the buyer information;
a memory device, accessible by the computer program and the promotion website, for storing data received by the computer program and the promotion website; and
means for sending information to the computing device the electronic voucher redeemable at the selected reseller.

2. The system of claim 1, further comprising a discount database, accessible by the computer program, the computer program having the ability to select a discount from the discount database.

3. The system of claim 1, further comprising a product database, accessible by the computer program, the computer program having the ability to display a product from the product database through the promotion website and to receive a product selection.

4. A system for providing an electronic voucher to a computing device, comprising:
a reseller website, accessible by the computing device via a network;
a promotion website linked to the reseller website;
a product webpage linked to the promotion website;
a computer program, executable through the product webpage, having the ability to receive buyer information, determine if a linking reseller is correct based on the buyer information, and to select a reseller based on the buyer information;
memory device, accessible by the computer program and the promotion website, for storing data received by the computer program and the promotion website; and
means for sending to the computing device an electronic voucher redeemable at the selected reseller.

5. The system of claim 4, further comprising a discount database, accessible by the computer program, the computer program having the ability to select a discount from the discount database.

6. The system of claim 4, further comprising a reseller database, accessible by the computer program, from which the reseller is selected.

7. The system of claim 4, wherein the electronic voucher identifies the reseller.

8. The system of claim 4, wherein the electronic voucher identifies an item selected from the group consisting of a reseller, a discount, a cash value discount, a free product upgrade, a discounted product upgrade, a free product option, a discounted product option, a free accessory, and a discounted accessory.

9. The system of claim 8, wherein the discount comprises an expiration date.

10. The system of claim 4, wherein the means for sending the electronic voucher includes an email program.

11. The system of claim 4, wherein the means for sending the electronic voucher includes means for displaying the information through the website.

12. The system of claim 4, wherein the means for sending the electronic voucher includes means displaying the information through the promotion website.

13. The system of claim 4, wherein the buyer information comprises a zip code.

14. The system of claim 13, wherein the reseller is selected based on the zip code.

15. A system for providing electronic vouchers, comprising:
a reseller website, accessible by a computing device via the Internet;
a promotion website linked to the reseller website;
a computer program, executable through the promotion website, having the ability to receive a zip code and an email address and determine if a linking reseller is correct based on the zip code;
a product database, accessible by the computer program, the computer program having the ability to display a product from the product database through the promotion website and to receive a product selection;
a memory, accessible by the computer program and the promotion website, for storing the linking reseller, the product selection, the zip code, and the email address;
a reseller database, accessible by the computer program, the computer program having the ability to select a reseller from the reseller database based on the zip code;
a discount database, accessible by the computer program, the computer program having the ability to select a cash value discount and an expiration date from the discount database based on the product selection; and
an email program, accessible by the computer program, for communicating to the computing device, the product selection, the reseller, and the electronic voucher indicating the cash value discount and the expiration date.

16. A system for providing electronic vouchers, comprising:
a reseller website, accessible by a remote device via the Internet;
a promotion website linked to the reseller website;
a product webpage linked to the promotion website;
a computer program, executable through the product webpage, having the ability to receive a zip code and an email address and determine if a linking reseller is correct based on the zip code;
a memory, accessible by the computer program and the promotion web site, for storing the linking reseller, the zip code, and the email address;
a reseller database, accessible by the computer program, the computer program having the ability to select a reseller from the reseller database based on the zip code;
a discount database, accessible by the computer program, the computer program having the ability to select a cash value discount;
and an expiration date from the discount database; and
an email program, accessible by the computer program, for communicating to the remote device, the electronic voucher indicating the reseller, the cash value discount, and the expiration date.

17. A method for providing electronic vouchers, comprising the steps of:
providing access to a reseller website to a buyer via a network;
displaying a promotion, receiving a promotion selection, and linking to a promotion website based on the promotion selection;
determining a linking reseller from the reseller website;
requesting buyer information, receiving the buyer information, and storing the information in a memory device;
determining if the linking reseller is correct based on the buyer information and if the linking reseller is not correct, selecting a reseller based on the buyer information; and
communicating the electronic voucher, redeemable at the reseller, to the buyer.

18. The method of claim 17, further comprising:
selecting a discount.

19. The method of claim 17, further comprising:
displaying a product from a product database;
receiving a product selection; and
storing the product selection in the memory device.

20. The method of claim 17, further comprising:
displaying a product;
receiving a product selection; and
linking to a product webpage based on the product selection.

21. The method of claim 17, further comprising the step of communicating a second set of information to the reseller.

22. The method of claim 21, wherein the second set of information comprises a discount and the buyer information.

23. A method for providing electronic vouchers, comprising:
providing access to a reseller website to a buyer via the Internet;
displaying a promotion, receiving a promotion selection, and linking to a promotion website based on the promotion selection;
determining a linking reseller from the reseller website;
displaying a product from a product database, receiving a product selection, and storing the product selection in a memory;
requesting a zip code and an email address, receiving the zip code and the email address, and storing the zip code and the email address in the memory;
determining if the linking reseller is correct based on the zip code and if the linking reseller is not correct, selecting a reseller from a reseller database located closest to the buyer based on the zip code;
selecting a cash value discount and an expiration date from a discount database based on the product selection; and
communicating an electronic voucher containing the product selection, the reseller, the cash value discount, and the expiration date to the email address via an email program.

24. A method for providing electronic vouchers, comprising:
providing access to a reseller website to a buyer via the Internet;
displaying a promotion, receiving a promotion selection, and linking to a promotion website based on the promotion selection;
determining a linking reseller from the reseller website;
displaying a product, receiving a product selection, and linking to a product webpage based on the product selection;
requesting a zip code and an email address, receiving the zip code and the email address, and storing the zip code and the email address in a memory;
determining if the linking reseller is correct based on the zip code and if the linking reseller is not correct, selecting a reseller from a reseller database located closest to the buyer based on the zip code;
selecting a cash value discount and an expiration date from a discount database based on the product selection; and
communicating an electronic voucher containing the product selection, the reseller, the cash value discount, and the expiration date to the email address via an email program.

25. A method for providing a discount to a buyer that is redeemable at a specific reseller, comprising the steps of:
advertising a cash value discount available for a product and an expiration date in a newspaper;
receiving a contact from a buyer via telephone regarding the discount;
receiving a product selection, a zip code, and an email address from the buyer;
selecting a reseller located geographically closest to the buyer based on the zip code; and
communicating the reseller to the buyer by sending an email to the email address.
